(19) United States
(12) Patent Application Publication
(10) Pub. No.: US 2012/0027983 A1
(43) Pub. Date: Feb. 2, 2012

(54) POLYAMIDE COMPOSITE STRUCTURES AND PROCESSES FOR THEIR PREPARATION FIELD OF THE INVENTION

(75) Inventor: Andri E. Elia, Chadds Ford, PA (US)

(73) Assignee: E. I. DU PONT DE NEMOURS AND COMPANY, Wilmington, DE (US)

(21) Appl. No.: 12/843,928

(22) Filed: Jul. 27, 2010

(51) Int. Cl. B32B 27/04; B29C 67/24; B32B 3/00

(52) U.S. Cl. 428/74; 442/64; 428/68; 264/271.1; 264/136

(57) ABSTRACT

The present invention relates to composite structures and overmolded structures comprising a fibrous material, a matrix resin composition and a portion of its surface made of a surface resin composition, wherein the surface resin composition is chosen from compositions comprising one or more polyamides and one or more functionalized polyolefins.

### FIELD OF THE INVENTION

The present invention relates to the field of polyamide composite structures suitable for overmolding an overmolding resin composition over at least a portion of their surface, overmolded composites structures and processes for their preparation.

### BACKGROUND OF THE INVENTION

With the aim of replacing metal parts for weight saving and cost reduction while having comparable or superior mechanical performance, structures based on composite materials comprising a polymer matrix containing a fibrous material have been developed. With this growing interest, fiber reinforced plastic composite structures have been designed because of their excellent physical properties resulting from the is combination of the fibrous material and the polymer matrix and are used in various end-use applications. Manufacturing techniques have been developed for improving the impregnation of the fibrous material with a polymer matrix to optimize the properties of the composite structure. In highly demanding applications, such as structural parts in automotive and aerospace applications, composite materials are desired due to a unique combination of lightweight, high strength and temperature resistance.

High performance composite structures can be obtained using thermosetting resins or thermoplastic resins as the polymer matrix. Thermoplastic-based composite structures present several advantages over thermoset-based composite structures such as, for example, the fact that they can be post-formed or reprocessed by the application of heat and pressure, that a reduced time is needed to make the composite structures because no curing step is required, and their increased potential for recycling. Indeed, the time consuming chemical reaction of cross-linking for thermosetting resins (curing) is not required during the processing of thermoplastics. Among thermoplastic resins, polyamides are particularly well suited for manufacturing composite structures.

Thermoplastic polyamide compositions are desirable for use in a wide range of applications including motorized vehicles applications; recreation and sport parts; household appliances, electrical/electronic parts; power equipment; and buildings or mechanical devices because of their good mechanical properties, heat resistance, impact resistance and chemical resistance and because they may be conveniently and flexibly molded into a variety of articles of varying degrees of complexity and intricacy.

Examples of composite structures based on thermoplastic polyamides are disclosed in U.S. Pat. App. Pub. No. 2008/0176090. The disclosed composite structures are said to have good mechanical properties and smooth surface appearance.

U.S. Pat. No. 4,255,219 discloses a thermoplastic sheet material useful in forming composites. The disclosed thermoplastic sheet material is made of polyamide 6 and a dibasic carboxylic acid or anhydride or esters thereof and at least one reinforcing mat of long glass fibers encased within said layer.

For making integrated composite structures and to increase the performance of polymers for the lowest article weight, it is often desired to “overmold” one or more parts made of a polymer onto a portion or all of the surfaces of a composite structure so as to surround or encapsulate said surfaces. Overmolding involves shaping, e.g. by injection molding, a second polymer part directly onto at least a portion of one or more surfaces of the composite structure, to form a two-part composite structure, wherein the two parts are adhered one to the other at least at one interface. The polymer compositions used to impregnate the fibrous material (i.e. the matrix polymer composition) and the polymer compositions used to overmold the impregnated fibrous material (i.e. the overmolding polymer composition) are desired to have good adhesion one to the other, extremely good dimensional stability and retain their mechanical properties under adverse conditions so that the composite structure is protected under operating conditions and thus has an increased lifetime.

Unfortunately, conventional polyamide compositions that are used to impregnate one or more fibrous reinforcement layers and to overmold the one or more impregnated fibrous layers may show poor adhesion between the overmolded polymer and the surface of the component comprising the fiber-reinforced material. The poor adhesion may result in the formation of cracks at the interface of the overmolded articles leading to premature aging and problems related to delamination and deterioration of the article upon use and time. To overcome poor adhesion between the overmolded polymer and the surface of the component comprising the fiber-reinforced material, it is a conventional practice to preheat the component comprising the fiber-reinforced material at a temperature close to but below the melt temperature of the polymer matrix prior to the overmolding step and then to rapidly transfer the heated structure for overmolding. However, such preheating step may be critical due to a potential thermal degradation of the structure and the transfer for overmolding may be complicated in terms of automation means and costs.

To overcome poor adhesion between the overmolded polymer and the surface of the component comprising the fiber-reinforced material, Int'l. Pat. App. Pub. No. WO 2007/149300 and U.S. Pat. App. Pub. No. 2008/0176090 disclose the use of a tie layer between the overmolded part and the component comprising the fiber-reinforced material.

Int'l Pat. App. Pub. No. WO 2007/149300 discloses a semi-aromatic polyamide composite article comprising a component comprising a fiber-reinforced material comprising a polyamide matrix composition, an overmolded component comprising a polyamide composition, and an optional tie layer therebetween, wherein at least one of the polyamide compositions is a semi-aromatic polyamide composition. U.S. Pat. App. Pub. No. 2008/0176090 dislcoses composite structures comprising a molded part comprising a fiber-reinforced material comprising a polyamide and/or polyester matrix and a thermoplastic polymeric film forming a surface of the composite structure. With the aim of enhancing adhesion of the film to the surface of the molded part, the thermoplastic polymeric film may be a multilayer comprising a tie layer.

While the use of a tie layer between the surface of the composite structure and the overmolding resin enhances adhesion; however, addition of a tie layer introduces an additional step to the overmolding process with loss of productivity. In addition to the benefits of high adhesion between the overmolded polymer and the surface of the component comprising the fiber-reinforced material, overmolded composite structures having high mechanical performance, especially flexural strength, are of interest, especially for the most highly demanding applications. Lower flexural strength in these most demanding applications may impair the durability and safety of the article upon use and time. Flexural strength, i.e. the maximum flexural stress sustained by the test specimen during a bending test, is commonly used as an indication of a material's ability to bear (or to sustain) load when flexed. When overmolding a resin composition onto at least a portion of a composite structure, high mechanical performance of the structure may be impaired because of poor bonding strength between the composite structure and the overmolding resin, e.g. in the case of flexural strength, the interface breaks first because of poor bonding strength, therefore the flex strength of the structure is less than either of its components.

There is a need for a composite structure suitable for overmolding an overmolding resin so that the overmolded composite structure exhibits good mechanical properties, especially flexural modulus with the absence of a tie layer.

### SUMMARY OF THE INVENTION

### Detailed Description

### Definitions

The following definitions are to be used to interpret the meaning of the terms discussed in the description and recited in the claims.

As used herein, the article “a” indicates one as well as more than one and does not necessarily limit its referent noun to the singular.

As used herein, the terms “about” and “at or about” mean that the amount or value in question may be the value designated or some other value about the same. The phrase is intended to convey that similar values promote equivalent results or effects.

### Composite Structures

The composite structures described herein comprise a fibrous material that is impregnated with a matrix resin composition, and the structure is particularly suitable for overmolding an overmolding resin composition over at least a portion of its surface. At least a portion of the surface of the composite structure is made of a surface resin composition.

Fibrous Material

For purposes herein, “a fibrous material being impregnated with a matrix resin composition” means that the matrix resin composition encapsulates and embeds the fibrous material so as to form an interpenetrating network of fibrous material substantially surrounded by the matrix resin composition. For purposes herein, the term “fiber” is defined as a, macroscopically homogeneous body having a high ratio of length to width across its cross-sectional area perpendicular to its length. The fiber cross section can be any shape, but is typically round.

The fibrous material may be in any suitable form known to those skilled in the art. Preferably the fibrous material is selected from the group consisting of non-woven structures, textiles, fibrous battings and combinations thereof. Non-woven structures can be selected from random fiber orientation or aligned fibrous structures. Examples of random fiber orientation include without limitation chopped and continuous fiber which can be in the form of a mat, a needled mat or a felt. Examples of aligned fibrous structures include without limitation unidirectional fiber strands, bidirectional strands, multidirectional strands, multi-axial textiles. Textiles can be from woven forms, knits, braids and combination thereof.

The fibrous material can be continuous or discontinuous in form. Depending on the end-use application of the composite structure and the required mechanical properties, more than one fibrous materials can be used, either by using the same fibrous materials or a combination of different fibrous materials, i.e. the composite structure described herein may comprise one or more fibrous materials. An example of a combination of different fibrous materials is a combination comprising a non-woven structure, such as for example a planar random mat which is placed as a central layer and one or more woven continuous fibrous materials that are placed as outside layers. Such a combination allows an improvement of the processing and, the homogeneity of the composite structure thus leading to improved mechanical properties. The fibrous material may be, any suitable material or a mixture of materials provided that the material or the mixture of materials withstand the processing conditions used during impregnation by the matrix resin composition and the polyamide surface resin composition.

Preferably, the fibrous material is made of glass fibers, carbon fibers, aramid fibers, graphite fibers, metal fibers, ceramic fibers, natural fibers or combinations thereof; more preferably, the fibrous material is made of glass fibers, carbon fibers, aramid fibers, natural fibers or mixtures thereof; and still more preferably, the fibrous material is made of glass fibers, carbon fibers and aramid fibers or mixture mixtures thereof. As mentioned above, more than one fibrous materials can be used. A combination of fibrous materials made of different fibers can be used such as for example a composite structure comprising one or more central layers made of glass fibers or natural fibers and one or more surface layers made of carbon fibers or glass fibers. Preferably, the fibrous material is selected from woven structures, non-woven structures or combinations thereof, wherein said structures are made of glass fibers and wherein the glass fibers are E-glass filaments with a diameter between 8 and 30 μm and preferably with a diameter between 10 to 24 μm.

The fibrous material may be a mixture of a thermoplastic material and the materials described above. For example, the fibrous material may be in the form of commingled or co-woven yarns or a fibrous material impregnated with a powder made of the thermoplastic material that is suited to subsequent processing into woven or non-woven forms, or a mixture for use as a uni-directional material.

Preferably, the ratio between the fibrous material and the polymer materials, i.e. the combination of the matrix resin composition and surface resin composition is at least 30% and more preferably between 40 and 80%, the percentage being a volume-percentage based on the total volume of the composite structure.

### Matrix Resin Compositions and Surface Resin Compositions

The matrix resin composition and the surface resin composition are the same or different and are chosen from thermoplastic compositions comprising a) one or more polyamides; and b) from at or about 1 to at or about 15 wt-% of one or more functionalized polyolefins, the weight percentages being based on the total weight of the thermoplastic composition. Depending on the end-use applications and the desired performance, the one or more polyamides are selected from aliphatic polyamides, semi-aromatic polyamides and combinations thereof.

Polyamides are condensation products of one or more dicarboxylic acids and one or more diamines, and/or one or more aminocarboxylic acids, and/or ring-opening polymerization products of one or more cyclic lactams. Preferably, the one or more polyamides are preferably selected from fully aliphatic polyamides, semi-aromatic polyamides and blends of the same, semi-aromatic polyamides being preferred.

The term “semi-aromatic” describes polyamides that comprise at least some monomers containing aromatic groups, in comparison with “fully aliphatic” polyamide which describes polyamides comprising aliphatic carboxylic acid monomer(s) and aliphatic diamine monomer(s).

Semi-aromatic polyamides may be derived from one or more aliphatic carboxylic acid components and aromatic diamine components. For example, m-xylylenediamine and p-xylylenediamine may derived be from one or more aromatic carboxylic acid components and one or more diamine components or may be derived from carboxylic acid components and diamine components.

Preferably, semi-aromatic polyamides are formed from one or more aromatic carboxylic acid components and one or more diamine components. The one or more aromatic carboxylic acids can be terephthalic acid or mixtures of terephthalic acid and one or more other carboxylic acids, like isophthalic acid, substituted phthalic acid such as for example 2-methylterephthalic acid and unsubstituted or substituted isomers of naphthalenedicarboxylic acid, wherein the carboxylic acid component contains at least 55 mole-% of terephthalic acid (the mole-% being based on the carboxylic acid mixture). Preferably, the one or more aromatic carboxylic acids are selected from terephthalic acid, isophthalic acid and mixtures thereof and more preferably, the one or more carboxylic acids are mixtures of terephthalic acid and isophthalic acid, wherein the mixture contains at least 55 mole-% of terephthalic acid. More preferably, the one or more carboxylic acids is 100% terephthalic acid.

Furthermore, the one or more carboxylic acids can be mixed with one or more aliphatic carboxylic acids, like adipic acid; pimelic acid; suberic acid; azelaic acid; sebacic acid and dodecanedioic acid, adipic acid being preferred. More preferably, the mixture of terephthalic acid and adipic acid comprised in the one or more carboxylic acids mixtures of the semi-aromatic polyamide contains at least 55 mole-% of terephthalic acid. one or more semi-aromatic polyamides described herein comprises one or more diamines that can be chosen among diamines having four or more carbon atoms, including, but not limited to, tetramethylene diamine, hexamethylene diamine, octamethylene diamine, decamethylene diamine, 2-methylpentamethylene diamine, 2-ethyltetramethylene diamine, 2-dimethyloctamethylene diamine; trimethylhexamethylene diamine, bis(p-aminocyclohexyl)methane; and/or mixtures thereof. Preferably, the one or more diamines of the semi-aromatic polyamides described herein are selected from hexamethylene diamine, 2-methyl pentamethylene diamine and mixtures thereof, and more preferably the one or more diamines of the semi-aromatic polyamides described herein are selected from hexamethylene diamine and mixtures of hexamethylene diamine and 2-methyl pentamethylene diamine wherein the mixture contains at least 50 mole-% of hexamethylene diamine (the mole-% being based on the diamines mixture). Examples of semi-aromatic polyamides useful in the compositions described herein are commercially available under the trademark Zytel® HTN from E. I. du Pont de Nemours and Company, Wilmington, Del.

Fully aliphatic polyamides are homopolymers, copolymers, or terpolymers formed from aliphatic and alicyclic monomers such as diamines, dicarboxylic acids, lactams, aminocarboxylic acids, and their reactive equivalents. Fully aliphatic polyamides preferably consist of aliphatic repeat units derived from monomers selected from one or more of the group consisting of:

i) aliphatic dicarboxylic acids having 6 to 20 carbon atoms and aliphatic diamines having 4 to 20 carbon atoms; and
ii) lactams and/or aminocarboxylic acids having 4 to 20 carbon atoms.

As used herein, the term “fully aliphatic polyamide” also refers to copolymers derived from two or more of such monomers and blends of two or more fully aliphatic polyamides.

Suitable aliphatic dicarboxylic acids having 6 to 20 carbon atoms include adipic acid (C6), pimelic acid (C7), suberic acid (C8), azelaic acid (C9), decanedioic acid (C10), undecanedioic acid (C11), dodecanedioic acid (C12), tridecanedioic acid (C13), tetradecanedioic acid (C14), and pentadecanedioic acid (C15), hexadecanoic acid (C16), octadecanoic acid (C18) and eicosanoic acid (C20).

Suitable aliphatic diamines having 4 to 20 carbon atoms include tetramethylene diamine, hexamethylene diamine, octamethylene diamine, nonamethylenediamine, decamethylene diamine, dodecamethylene diamine, 2-methylpentamethylene diamine, 2-ethyltetramethylene diamine, 2-methyloctamethylenediamine, trimethylhexamethylenediamine, and bis(p-aminocyclohexyl)methane.

Suitable lactams are caprolactam and laurolactam.

Preferred fully aliphatic polyamides include PA46, PA6; PA66; PA610; PA612; PA613; PA614; PA 615; PA616; PA10; PA11; PA 12; PA1010; PA1012; PA1013; PA1014; PA1210; PA1212; PA1213; 1214 and copolymers and blends of the same. More preferred examples of fully aliphatic polyamides in the matrix resin composition and/or surface resin composition and/or overmolding resin composition described herein are PA66 (poly(hexamethylene adipamide), PA612 (poly(hexamethylene dodecanoamide) and blends of the same and are commercially available under the trademark Zytel® from E. I. du Pont de Nemours and Company, Wilmington, Del.

In repeat units comprising a diamine and a dicarboxylic acid, the diamine is designated first. Repeat units derived from other amino acids or lactams are designated as single numbers designating the number of carbon atoms. The following list exemplifies the abbreviations used to identify monomers and repeat units in the polyamides (PA):
HMD hexamethylene diamine (or 6 when used in combination with a diacid)
AA Adipic acid
DMD Decamethylenediamine
DDMD Dodecamethylenediamine
TMD Tetramethylenediamine
polymer repeat unit formed from TMD and AA
6 polymer repeat unit formed from s-caprolactam
66 polymer repeat unit formed from HMD and AA
610 polymer repeat unit formed from HMD and decanedioic acid
612 polymer repeat unit formed from HMD and dodecanedioic acid
613 polymer repeat unit formed from HMD and tridecanedioic acid
614 polymer repeat unit formed from HMD and tetradecanedioic acid
615 polymer repeat unit formed from HMD and pentadecanedioic acid
616 polymer repeat unit formed from HMD and hexadecanoic acid
10 polymer repeat unit formed from 10-aminodecanoic acid
1010 polymer repeat unit formed from DMD and decanedioic acid
1012 polymer repeat unit formed from DMD and dodecanedioic acid
1013 polymer repeat unit formed from DMD and tridecanedioic acid
1014 polymer repeat unit formed from DMD and tetradecanedioic acid
11 polymer repeat unit formed from 11-aminoundecanoic acid
12 polymer repeat unit formed from 12-aminododecanoic acid
1210 polymer repeat unit formed from DDMD and decanedioic acid
1212 polymer repeat unit formed from DDMD and dodecanedioic acid
1213 polymer repeat unit formed from DDMD and tridecanedioic acid
1214 polymer repeat unit formed from DDMD and tetradecanedioic acid

Functionalized Polyolefins

The thermoplastic compositions described herein comprise from at or about 1 to at or about 15 wt-% of one or more functionalized polyolefins, preferably form at or about 3 to at or about 10 wt-%, the weight percentages being based on the total weight of the thermoplastic composition. The term “functionalized polyolefin” refers to an alkylcarboxyl-substituted polyolefin, which is a polyolefin that has carboxylic moieties attached thereto, either on the polyolefin backbone itself or on side chains. The term “carboxylic moiety” refers to carboxylic to groups, such as carboxylic acids, carboxylic acid ester, carboxylic acid anhydrides and carboxylic acid salts.

The one or more functionalized polyolefins are preferably selected from grafted polyolefins, ethylene acid copolymers, ionomers, ethylene epoxide copolymers and mixtures thereof.

Functionalized polyolefins may be prepared by direct synthesis or by grafting. An example of direct synthesis is the polymerization of ethylene and/or at least one alpha-olefin with at least one ethylenically unsaturated monomer having a carboxylic moiety. An example of grafting process is the addition of at least one ethylenically unsaturated monomer having at least one carboxylic moiety to a polyolefin backbone. The ethylenically unsaturated monomers having at least one carboxylic moiety may be, for example, mono-, di-, or polycarboxylic acids and/or their derivatives, including esters, anhydrides, salts, amides, imides, and the like.

Suitable ethylenically unsaturated monomers include methacrylic acid; acrylic acid; ethacrylic acid; glycidyl methacrylate; 2-hydroxy ethylacrylate; 2-hydroxy ethyl methacrylate; butyl acrylate; n-butyl acrylate; diethyl maleate; monoethyl maleate; di-n-butyl maleate; maleic anhydride; maleic acid; fumaric acid; mono- and disodium maleate; acrylamide; glycidyl methacrylate; dimethyl fumarate; crotonic acid, itaconic acid, itaconic anhydride; tetrahydrophthalic anhydride; monoesters of these dicarboxylic acids; dodecenyl succinic anhydride; 5-norbornene-2,3-anhydride; nadic anhydride (3,6-endomethylene-1,2,3,6-tetrahydrophthalic anhydride); nadic methyl anhydride; and the like.

Grafting agents of grafted polyolefins, i.e. the at least one monomer having at least one carboxylic moiety, is preferably present in the one or more functionalized polyolefins in an amount from at or about 0.05 to at or about 6 weight percent, preferably from at or about 0.1 to at or about 2.0 weight percent, the weight percentages being based of the total weight of the one or more functionalized polyolefins. Grafted polyolefins are preferably derived by grafting at least one monomer having at least one carboxylic moiety to a polyolefin, an ethylene alpha-olefin or a copolymer derived from at least one alpha-olefin and a diene. Preferably, the one or more grafted polyolefins are selected from the group consisting of grafted polyethylenes, grafted polypropylenes, grafted ethylene alpha-olefin copolymers, grafted copolymers derived from at least one alpha-olefin and a diene and combinations thereof. More preferably, the one or more functionalized polyolefins are maleic anhydride grafted polyolefins selected from the group consisting of maleic anhydride grafted polyethylenes, maleic anhydride grafted polypropylenes, maleic anhydride grafted ethylene alpha-olefin copolymers, maleic anhydride grafted copolymers derived from at least one alpha-olefin and a diene and mixtures thereof. Polyethylenes used for preparing maleic anhydride grafted polyethylene (MAH-g-PE) are commonly available polyethylene resins selected from HDPE (density higher than 0.94 g/cm³), LLDPE (density of 0.915-0.925 g/cm³) or LDPE (density of 0.91-0.94 g/cm³). Polypropylenes used for preparing maleic anhydride grafted polypropylene (MAH-g-PP) are commonly available copolymer or homopolymer polypropylene resins.

Ethylene alpha-olefins copolymers comprise ethylene and one or more alpha-olefins, preferably the one or more alpha-olefins have 3-12 carbon atoms. Examples of alpha-olefins include but are not limited to propylene, 1-butene, 1-pentene, 1-hexene-1,4-methyl 1-pentene, 1-heptene, 1-octene, 1-nonene, 1-decene, 1-undecene and 1-dodecene. Preferably the ethylene alpha-olefin copolymer comprises from at or about 20 to at or about 96 weight percent of ethylene and more preferably from at or about 25 to at or about 85 weight percent; and from at or about 4 to at or about 80 weight percent of the one or more alpha-olefins and more preferably from at or about 15 to at or about 75 weight percent, the weight percentages being based on the total weight of the ethylene alpha-olefins copolymers. Preferred ethylene alpha-olefins copolymers are ethylene-propylene copolymers and ethylene-octene copolymers. Copolymers derived from at least one alpha-olefin and a diene are preferably derived from alpha-olefins having preferably 3-8 carbon atoms. Preferred copolymers derived from at least one alpha-olefin and a diene are ethylene propylene diene elastomers. The term “ethylene propylene diene elastomers (EPDM)” refers to any elastomer that is a terpolymer of ethylene, at least one alpha-olefin, and a copolymerizable non-conjugated diene such as norbornadiene, 5-ethylidene-2-norbornene, dicyclopentadiene, 1,4-hexadiene and the like. When a functionalized ethylene propylene diene elastomer is comprised in the resin composition described herein, the ethylene propylene diene polymer preferably comprise from at or about 50 to at or about 80 weight percent of ethylene, from at or about 10 to at or about 50 weight percent of propylene and from at or about 0.5 to at or about 10 weight percent of at least one diene, the weight percentages being based on the total weight of the ethylene propylene diene elastomer.

Ethylene acid copolymers are thermoplastic ethylene copolymers comprising repeat units derived from ethylene and one or more α,β-ethylenically unsaturated carboxylic acids comprising from 3 to 8 carbon atoms. The ethylene acid copolymers may optionally contain a third softening monomer. This “softening” monomer decreases the crystallinity of the ethylene acid copolymer. Ethylene acid copolymers can thus be described as E/X/Y copolymers, wherein E an olefin, such as ethylene; wherein X is an α,β-ethylenically unsaturated carboxylic acid, and wherein Y represents copolymerized units of the softening comonomer (e.g. alkyl acrylates and alkyl methacrylates, wherein the alkyl groups have from 1 to 8 carbon atoms). The amount of X in the ethylene acid copolymer is from at or about 1 to at or about 35 wt-%, and the amount of Y is from 0 to about 59 wt-%, the weight percentage being based on the total weight of the ethylene acid copolymer. Preferred examples ethylene acid copolymers are ethylene acrylic acid and ethylene methacrylic acid copolymers, ethylene methacrylic acid being especially preferred.

Ionomers are thermoplastic resins that contain metal ions in addition to the organic backbone of the polymer. Ionomers are ionic ethylene copolymers with partially neutralized (from 3 to 99.9%) α,β-unsaturated carboxylic acid selected from the group consisting of acrylic acid (AA), methacrylic acid (MAA), maleic acid, fumaric acid, itaconic acid, and half esters of maleic, maleic acid monoethylester (MAME), fumaric and itaconic acid.

Ionomers may optionally comprise a softening comonomer of formula (A):

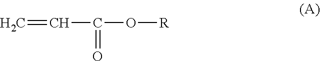

where R is selected from the group consisting of n-propyl, n-pentyl, n-hexyl, n-heptyl, n-octyl, n-nonyl, 2-ethylhexyl, 2-methoxyethyl, 2-ethoxyethyl, 3-methoxypropyl, 3-ethoxypropyl and 3-methoxybutyl.

Overall, ionomers can be described as E/X/Y copolymers where E is an olefin such as ethylene, X is a α,β-unsaturated carboxylic acid selected from the group consisting of acrylic acid (AA), methacrylic acid (MAA), maleic acid, fumaric acid, itaconic acid, and half esters of maleic, maleic acid monoethylester (MAME), fumaric and itaconic acid; and wherein Y is a softening comonomer of formula (A), wherein X is from at or about 1 wt-% to at or about 20 wt-% of the E/X/Y copolymer and Y can be present in an amount of from about 0 to about 50 wt-% of the E/X/Y copolymer, wherein the carboxylic acid functionalities are at least partially neutralized. Preferably, the carboxylic acid functionalities are at least partially neutralized and the E/X/Y copolymers has from at or about 3 to at or about 90%, more preferably from at or about 35 to at or about 70%, of the carboxylic acid functionalities neutralized. Preferably, the carboxylic acid functionalities are at least partially neutralized by one or more metal ions selected from groups Ia, IIa, IIb, IIIa, IVa, VIb and VIII of the Periodic Table of the Elements, more preferably by one or more metal ions selected from alkali metals like lithium, sodium or potassium or transition metals like manganese and zinc, and still more preferably by one or more metal ions selected from sodium, potassium, zinc, calcium and magnesium.

Suitable ionomers can be prepared from the ethylene acid copolymers described above. Suitable ionomers for use in the present invention are commercially available under the trademark Surlyn® from E. I. du Pont de Nemours and Company, Wilmington, Del.

Ethylene epoxide copolymers are ethylene copolymers that are functionalized with epoxy groups; by “functionalized”, it is meant that the groups are grafted and/or copolymerized with organic functionalities. Examples of epoxides used to functionalize copolymers are unsaturated epoxides comprising from four to eleven carbon atoms, such as glycidyl (meth)acrylate, allyl glycidyl ether, vinyl glycidyl ether and glycidyl itaconate, glycidyl (meth)acrylates (GMA) being particularly preferred. Ethylene epoxide copolymers preferably contain from 0.05 to 15 wt-% of epoxy groups, the weight percentage being based on the total weight of the ethylene epoxide copolymer. Preferably, epoxides used to functionalize ethylene copolymers are glycidyl (meth)acrylates. The ethylene/glycidyl (meth)acrylate copolymer may further contain copolymerized units of an alkyl (meth)acrylate having from one to six carbon atoms and an α-olefin having 1-8 carbon atoms. Representative alkyl (meth)acrylates include methyl (meth)acrylate, ethyl (meth)acrylate, propyl (meth)acrylate, butyl (meth)acrylate, isobutyl (meth)acrylate, hexyl (meth)acrylate, or combinations of two or more thereof. Of note are ethyl acrylate and butyl acrylate.

Preferably, the one or more functionalized polyolefins are chosen from maleic anhydride grafted polyolefins, ethylene acid copolymers, ionomers, ethylene epoxide copolymers and mixtures thereof.

More preferably, the one or more functionalized polyolefins are chosen from maleic anhydride grafted polyolefins, ionomers and mixtures thereof.

Still more preferably, the one or more functionalized polyolefins are ionomers selected from E/XIY copolymers, where E is an olefin such as ethylene, X is a α,β-unsaturated carboxylic acid selected from the group consisting of acrylic acid (AA), methacrylic acid (MAA), maleic acid, fumaric acid, itaconic acid, and half esters of maleic, maleic acid monoethylester (MAME), fumaric and itaconic acid, and Y is a softening comonomer of formula (A), wherein X is from at or about 1 wt-% to at or about 20 wt-% of the E/X/Y copolymer and Y can be present in an amount of from about 5 to about 35 wt-% of the E/X/Y copolymer, wherein the carboxylic acid functionalities are at least partially neutralized. Preferably, the carboxylic acid functionalities are at least partially neutralized. It is also preferable that the E/X/Y copolymers has from at or about 3 to at or about 90%, more preferably from at or about 35 to at or about 75%, of the carboxylic acid functionalities neutralized. Preferably, the carboxylic acid functionalities are at least partially neutralized by one or more metal ions selected from groups Ia, IIa, IIb, IIIa, IVa, VIb and VIII of the Periodic Table of the Elements, more preferably by one or more metal ions selected from alkali metals like lithium, sodium or potassium or transition metals like manganese and zinc, and still more preferably by one or more metal ions selected from sodium, potassium, zinc, calcium and magnesium.

Still more preferably, the one or more functionalized polyolefins are ionomers selected from E/X/Y copolymers, where E is an olefin such as ethylene, X is a α,β-unsaturated carboxylic acid selected from the group consisting of acrylic acid (AA), methacrylic acid (MAA), maleic acid, fumaric acid, itaconic acid, and half esters of maleic, maleic acid monoethylester (MAME), fumaric and itaconic acid, and Y is a softening comonomer of formula (A), wherein X is from at or about 7 wt-% to at or about 15 wt-% of the E/X/Y copolymer and Y can be present in an amount of from about 10 to about 30 wt-% of the E/X/Y copolymer, wherein the carboxylic acid functionalities are at least partially neutralized. Preferably, the carboxylic acid functionalities are at least partially neutralized. It is also preferable that the E/X/Y copolymers has from at or about 3 to at or about 90%, more preferably from at or about 35 to at or about 70%, of the carboxylic acid functionalities neutralized. Preferably, the carboxylic acid functionalities are at least partially neutralized by one or more metal ions selected from groups Ia, IIa, IIb, IIIa, IVa, VIb and VIII of the Periodic Table of the Elements, more preferably by one or more metal ions selected from alkali metals like lithium, sodium or potassium or transition metals like manganese and zinc, and still more preferably by one or more metal ions selected from sodium, potassium, zinc, calcium and magnesium.

The surface resin composition described herein and/or the matrix resin composition may further comprise one or more impact modifiers, one or more heat stabilizers, one or more reinforcing agents, one or more ultraviolet light stabilizers, one or more flame retardant agents or combinations thereof.

The surface resin composition described herein and/or the matrix resin composition may further comprise modifiers and other ingredients, including, without limitation, flow enhancing additives, lubricants, antistatic agents, coloring agents (including dyes, pigments, carbon black, and the like), flame retardants, nucleating agents, crystallization promoting agents and other processing aids known in the polymer compounding art.

Fillers, modifiers and other ingredients described above may be present in the composition in amounts and in forms well known in the art, including in the form of so-called nano-materials where at least one of the dimensions of the particles is in the range of 1 to 1000 nm.

Making the Compositions

Preferably, the surface resin compositions and the matrix resin compositions described herein are melt-mixed blends, wherein all of the polymeric components are well-dispersed within each other and all of the non-polymeric ingredients are well-dispersed in and bound by the polymer matrix, such that the blend forms a unified whole. Any melt-mixing method may be used to combine the polymeric components and non-polymeric ingredients of the present invention. For example, the polymeric components and non-polymeric ingredients may be added to a melt mixer, such as, for example, a single or twin-screw extruder; a blender; a single or twin-screw kneader; or a Banbury mixer, either all at once through a single step addition, or in a stepwise fashion, and then melt-mixed. When adding the polymeric components and non-polymeric ingredients in a stepwise fashion, part of the polymeric components and/or non-polymeric ingredients are first added and melt-mixed with the remaining polymeric components and non-polymeric ingredients being subsequently added and further melt-mixed until a well-mixed composition is obtained.

Depending on the end-use application, the composite structure described herein may have any shape. Preferably, the composite structure described herein is in the form of a sheet structure.

Making the Composite Structures

Also described herein are processes for making the composite structures described above and the composite structures obtained thereof. The processes comprise a step of i) impregnating with the matrix resin composition the fibrous material, wherein at least a portion of the surface of the composite structure is made of the surface resin composition. Also described herein are processes for making the composite structures described herein, wherein the processes comprise a step of applying a surface resin composition to at least a portion of the surface of the fibrous material which is impregnated with a matrix resin composition described herein.

Preferably, the fibrous material is impregnated with the matrix resin by thermopressing. During thermopressing, the fibrous material, the matrix resin composition and the surface resin composition undergo heat and pressure in order to allow the plastics to melt and penetrate through the fibrous material and, therefore, to impregnate said fibrous material. Typically, thermopressing is made at a pressure between 2 and 100 bars and more preferably between 10 and 40 bars and a temperature which is above the melting point of the matrix resin composition and the polyamide composition, preferably at least about 20° C. above the melting point to enable a proper impregnation. The heating step may be done by a variety of thermal means, including contact heating, radiant gas heating, infra red heating, convection or forced convection air heating or microwave heating. The driving impregnation pressure can be applied by a static process or by a continuous process (also known as dynamic process), a continuous process being preferred. Examples of impregnation processes include without limitation vacuum molding, in-mold coating, cross-die extrusion, pultrusion, wire coating type processes, lamination, stamping, diaphragm forming or press-molding, lamination being preferred. During lamination, heat and pressure are applied to the fibrous material, the matrix resin composition and the surface resin composition through opposing pressured rollers in a heating zone. Examples of lamination techniques include without limitation calendering, flatbed lamination and double-belt press lamination. When lamination is used as the impregnating process, preferably a double-belt press is used for lamination.

The matrix resin composition and the surface resin composition are applied to the fibrous material by conventional means such as for example powder coating, film lamination, extrusion coating or a combination of two or more thereof, provided that the surface resin composition is applied on at least a portion of the surface of the composite structure so as to be accessible if an overmolding resin is applied onto the composite structure.

During a powder coating process, a polymer powder which has been obtained by conventional grinding methods is applied to the fibrous material. The powder may be applied onto the fibrous material by scattering, sprinkling, spraying, thermal or flame spraying, or fluidized bed coating methods. Optionally, the powder coating process may further comprise a step which consists in a post sintering step of the powder on the fibrous material. The matrix resin composition and the surface resin composition are applied to the fibrous material such that at least of portion of surface of the composite structure is made of the polyimide surface resin composition. Subsequently, thermopressing is achieved on the powder coated fibrous material, with an optional preheating of the powdered fibrous material outside of the pressurized zone. During film lamination, one or more films made of the matrix resin composition and one or more films made of the surface resin composition which have been obtained by conventional extrusion methods known in the art such as for example blow film extrusion, cast film extrusion and cast sheet extrusion are applied to the fibrous material. Subsequently, thermopressing is achieved on the assembly comprising the one or more films made of the matrix resin composition and the one or more films made of the surface resin composition and the one or more fibrous materials. In the resulting composite structure, the film resins have penetrated into the fibrous material as a polymer continuum surrounding the fibrous material. During extrusion coating, pellets and/or granulates made of the matrix resin composition and pellets and/or granulates made of the surface resin composition are extruded through one or more flat dies so as to form one or more melt curtains which are then applied onto the fibrous material by laying down the one or more melt curtains.

Depending on the end-use application, the composite structure obtained under the impregnating step i) may be shaped into a desired geometry or configuration, or used in sheet form. The process for making a composite structure described herein may further comprise a step ii) of shaping the composite structure, said step arising after the impregnating step i). The step of shaping the composite structure obtained under step i) may be done by compression molding, stamping or any technique using heat and pressure. Preferably, pressure is applied by using a hydraulic molding press. During compression molding or stamping, the composite structure is preheated to a temperature above the melt temperature of the surface resin composition and is transferred to a forming means such as a molding press containing a mold having a cavity of the shape of the final desired geometry whereby it is shaped into a desired configuration and is thereafter removed from the press or the mold after cooling to a temperature below the melt temperature of the surface resin composition.

Overmolded Composite Structures

Another embodiment of the present invention relates to overmolded composite structures and processes to make them. The overmolded composite structure according to the present invention comprises at least two components, i.e. a first component and a second component. The first component comprises a composite structure as described above. The second component comprises an overmolding resin composition. The overmolded composite structure may comprise more than one first components, i.e. it may comprise more than one composite structures. The overmolding resin composition comprises one or more thermoplastic to resins that are compatible with the surface resin composition. Preferably, the overmolding resin composition comprises one or more polyamides such as those described herein for the matrix resin compositions and the surface resin compositions.

The overmolding resin composition described herein may further comprise one or more impact modifiers, one or more heat stabilizers, one or more oxidative stabilizers, one or more reinforcing agents, one or more ultraviolet light stabilizers, one or more flame retardant agents or combinations thereof such as those described above for the surface resin composition and/or the matrix resin composition. When comprised in the overmolding resin compositions, these additives are present in amounts described above for the surface resin composition and/or the matrix resin composition.

The second component is adhered to the first component over at least a portion of the surface of said first component, said portion of the surface being made of the surface resin composition described above. Preferably, the second component is adhered to the first component over at least a portion of the surface of said first component without additional adhesive, tie layer or adhesive layer. The first component, i.e. the composite structure, may be fully or partially encapsulated by the second component. Preferably, the first component, i.e. the composite structure described above, is in the form of a sheet structure.

The overmolding resin compositions described herein are preferably melt-mixed blends, wherein all of the polymeric components are well-dispersed within each other and all of the non-polymeric ingredients are well-dispersed in and bound by the polymer matrix, such that the blend forms a unified whole. Melt-mixing methods that can be used are described above for the preparation of the polyamide surface resin compositions and the matrix resin compositions.

Making the Overmolded Composite Structures

In another aspect, the present invention relates to a process for making the overmolded composite structures described above and the overmolded composite structures obtained thereof. The process for making the overmolded composite structure comprising a step of overmolding the first component, i.e. the composite structure described above, with the overmolding resin composition. By “overmolding”, it is meant that a second component is molded onto at least one portion of the surface of a first component.

The first component, i.e. the composite structure described above, is positioned in a molding station comprising a mold having a cavity defining the greater portion of the outer surface configuration of the final overmolded composite structure. The overmolding resin composition may be overmolded on one side or on both sides of the composite structure and it may fully or partially encapsulate the first component. After having positioned the first component in the molding station, the overmolding resin composition is then introduced in a molten form. The first component and the second component are adhered together by overmolding.

The overmolding process includes that the second component is molded in a mold already containing the first component, the latter having been manufactured beforehand as described above, so that first and second components are adhered to each other over at least a portion of the surface of said first component. The at least two parts are preferably adhered together by injection or compression molding as an overmolding step, and more preferably by injection molding. When the overmolding resin composition is introduced in a molten form in the molding station so as to be in contact with the first component, at least a thin layer of an element of the first component is melted and becomes intermixed with the overmolding resin composition.

Depending on the end-use application, the first component, i.e. the composite structure, may be shaped into a desired geometry or configuration prior to the step of overmolding the overmolding resin composition. As mentioned above, the step of shaping the first component, i.e. the composite structure, may done by compression molding, stamping or any technique using heat and pressure, compression molding and stamping being preferred. During stamping, the first component, i.e. the composite structure, is preheated to a temperature above the melt temperature of the surface resin composition and is transferred to a stamping press or a mold having a cavity of the shape of the final desired geometry and it is then stamped into a desired configuration and is thereafter removed from the press or the mold. With the aim of improving the adhesion between the overmolding resin and the surface resin composition, the surface of the first component, i.e. the composite structure, may be a textured surface so as to increase the relative surface available for overmolding. Such textured surface may be obtained during the step of shaping by using a press or a mold having for example porosities or indentations on its surface.

Alternatively, a one step process comprising the steps of shaping and overmolding the first component in a single molding station may be used. This one step process avoids the step of compression molding or stamping the first component in a mold or a press, avoids the optional preheating step and the transfer of the preheated first component to the molding station. During this one step process, the first component, i.e. the composite structure, is heated outside, adjacent to or within the molding station, to a temperature at which the first component is conformable or shapable during the overmolding step, and preferably it is heated to a temperature below the melt temperature of the composite structure. In such a one step process, the molding station comprises a mold having a cavity of the shape of the final desired geometry. The shape of the first component is thereby obtained during overmolding.

Also described herein are uses of from at or about 1 to at or about 15 wt-% of the one or more functionalized polyolefins described above in thermoplastic compositions comprising a) one or more polyamides described above for improving the flexural strength of a composite structure having a surface, which surface has at least a portion made of a surface resin composition, and comprising a fibrous material selected from non-woven structures, textiles, fibrous battings and combinations thereof, said fibrous material being impregnated with a matrix resin composition, wherein the surface resin composition and the matrix resin composition to are identical or different and are chosen from the thermoplastic compositions comprising a) one or more polyamides and mixtures thereof, the weight percentages being based on the total weight of the thermoplastic composition.

Also described herein are uses of from at or about 1 to at or about 15 wt-% of the one or more functionalized polyolefins described above in thermoplastic compositions comprising a) one or more polyamides described above for improving the flexural strength of an overmolded composite structure comprising a first component having a surface and a second component of an overmolded composite structure, the weight percentage being based on the total weight of the one or more functionalized polyolefins and the one or more polyamides, wherein the second component is adhered to said first component over at least a portion of the surface of said first component,
wherein the surface of the first component has at least a portion made of a surface resin composition, and comprises a fibrous material selected from non-woven structures, textiles, fibrous battings and combinations thereof such as those described above, said fibrous material being impregnated with a matrix resin composition, wherein the second component comprises an overmolding resin composition comprising one or more thermoplastic resins, and
wherein the matrix resin composition and the surface resin composition are identical or different and are chosen from thermoplastic compositions comprising a) one or more polyamides thereof described above.

Articles

The composite structures and the overmolded composite structures described herein may be used in a wide variety of applications such as components for automobiles, trucks, commercial airplanes, aerospace, rail, household appliances, computer hardware, hand held devices, recreation and sports, structural component for machines, structural components for buildings, structural components for photovoltaic equipments or structural components for mechanical devices.

Examples of automotive applications include without limitation seating components and seating frames, engine cover brackets, engine cradles, suspension cradles, spare tire wells, chassis reinforcement, floor pans, front-end modules, steering column frames, instrument panels, door systems, body panels (such as horizontal body panels and door panels), tailgates, hardtop frame structures, convertible top frame structures, roofing structures, engine covers, housings for transmission and power delivery components, oil pans, airbag housing canisters, automotive interior impact structures, engine support brackets, cross car beams, bumper beams, pedestrian safety beams, firewalls, rear parcel shelves, cross vehicle bulkheads, pressure vessels such as refrigerant bottles and fire extinguishers and truck compressed air brake system vessels, hybrid internal combustion/electric or electric vehicle battery trays, automotive suspension wishbone and control arms, suspension stabilizer links, leaf springs, vehicle wheels, recreational vehicle and motorcycle swing arms, fenders, roofing frames and tank flaps.

Examples of household appliances include without limitation washers, dryers, refrigerators, air conditioning and heating. Examples of recreation and sports include without limitation inline-skate components, baseball bats, hockey sticks, ski and snowboard bindings, rucksack backs and frames, and bicycle frames. Examples of structural components for machines include electrical/electronic parts such as housings for hand held electronic devices, computers.

### Examples

The following materials were used for preparing the composites structures and overmolded composite structures according to the present invention and comparative examples.

### Materials

The materials below make up the compositions used in the Examples and Comparative Examples

Semi-aromatic polyamide (PA1): polyamide (PA) made of terephthalic acid and 1,6-hexamethylenediamine (HMD) and 2-methylpentamethylenediamine (MPMD) (HMD:MPMD=50:50) and having a melting point of about 305-315° C. This semi-aromatic polyamide is commercially available from E. I. du Pont de Nemours.

Overmoldinq resin composition (C2): a composition comprising 50 wt-% of long glass fibers and comprising the semi-aromatic PA1. This composition is commercially available from E. I. du Pont de Nemours.

Functionalized polyolefin (Ionomer): an ionomer being poly(ethylene/n-butyl acrylate/methacrylic acid) (E/n-BA/MAA) at approximate degree of neutralization of 70 percent with zinc ions. The ionomer contains 67 wt-% ethylene, 24 wt-% n-butyl acrylate and 9 wt-% methacrylic acid. This ionomer is commercially available from E. I. du Pont de Nemours.

### Preparation of Films

Compositions comprising a blend of 95 wt-% of the semi-aromatic polyamide PA1 and 5 wt-% of ionomer were prepared by melt blending a cube-blend mixture of the two ingredients in situ in a ZSK 28 mm twin-screw extruder while making the films. Films having a thickness of about 10 mil (254 microns) and made of the compositions listed in Table 1 and Table 2 were prepared by melting the semi-aromatic polyamide PA1 or the mixture of the semi-aromatic polyamide PA1 and the functionalized polyolefin (ionomer) in a ZSK 28 mm twin-screw extruder equipped with a film die and a casting drum. The films were processed with a melt temperature of about 337° C. and cast at a temperature of about 150° C.

### Preparation of the Composite Structures

The composite structures C1 and E1 used for preparing the overmolding composite structures C3 and E2 were prepared by compression molding a stack of nine layers made of the films obtained as described above alternating with eight layers of woven continuous glass fiber sheets into a 2 mm thick sheet.

### Preparation of the Overmolded Composite Structures

The composite structures C1 and E1 were cut into 1.0 in×8 in (2.5 cm×20.3 cm) rectangular bars and preheated to 150° C. for at least 15 minutes, and then placed in a mold cavity of an injection molding machine (125 ton Engel). The mold was electrically heated at 150° C. and fitted with a 1.0 in×8 in× 3/16 in bar cavity with a bar gate. The injection machine was set at 325° C.

The composite structures C1 and E1 were overmolded with the overmolding resin composition C2 (a composition comprising 50 wt-% of long glass fibers and comprising the polyamide (PA1) made of terephthalic acid and 1,6-hexamethylenediamine (HMD) and 2-methylpentamethylenediamine (MPMD) (HMD:MPMD=50:50) described above) such that the resulting overmolded composite structures had a thickness of about 0.18 ( 3/16) in (4.5 mm).

In the case of the overmolding resin C2, the overmolding resin composition was injection molded under the same molding conditions as described above into the same cavity without any composite structure.

### Heat Deflection Temperature

Heat deflection temperature of the composite structures (C1 and E1) were measured according to ISO 75 at 1.82 MPa load.

### Flexural Strength

The composite structures (C1 and E1) listed in Table 1 were cut into about 0.5 in×about 5 in (1.3 cm×12.7 cm) rectangular bars (specimen test size as per method iso 178) and flexural strength was measured.

For comparison, a test specimen (C2:C2) of overmolding resin composition (C2) overmolded on itself was prepared. The overmolding resin composition (C2) was injection molded onto parts (specimen test size as per method ISO 178) having the same thickness as those prepared from the composite structures.

The composite structures (C1 and E1) listed in Table 1 and the overmolded composite structures (C3 and E2), the overmolding resin parts (C2:C2) listed in Table 2 were cut with a water jet into the required geometry (specimen test size as per method ISO 178, e.g. about 0.5 in×about 5 in (1.3 cm×12.7 cm) rectangular bars) for the determination of flexural strength, and the corresponding test results are shown in Table 1 and Table 2. Table 1 and Table 2 give average values obtained from five specimens. In the Tables, composites and overmolded composites of the Examples are identified as “E” and composites and overmolded composites of the Comparative Examples as “C”.

Flexural testing was performed according to ISO 178 with a strain rate of 50 mm/min. For the overmolded composite structures C3 and E2, the test specimens were positioned with the composite structure face or with the overmolded composite face up, and these two results from each are reported in Table 2.

TABLE 1
Resin compositions used for preparing the composite structures according
to the present invention (E1) and comparative example (C1) and results

| | Composite | Composite structure |
|---|---|---|
| | structure C1 | E1 |
| Surface resin composition | Semi-aromatic | Blend of: |
| | PA (PA1) | 95 wt-% of PA1 and |
| | | 5 wt-% of ionomer |
| Matrix resin composition | Semi-aromatic | Blend of: |
| | PA (PA1) | 95 wt-% of PA1 and |
| | | 5 wt-% of ionomer |
| Overmolding resin composition | — | — |
| Heat Deflection Temperature/° C. | 311 | 311 |
| Flexural strength/MPa | 648 | 645 |

TABLE 2
Resin compositions used for preparing the overmolded composite structures according to
the present invention (E2) and comparative examples (C3 and C4) and results

| | Overmolding resin | Overmolded composite structure | Overmolded composite structure |
|---|---|---|---|
| | C2:C2 | C3 | E2 |
| Surface resin composition | — | Semi-aromatic PA (PA1) | Blend of: |
| | | | 95 wt-% of PA1 and 5 wt-% of ionomer |
| Matrix resin composition | — | Semi-aromatic PA (PA1) | Blend of: |
| | | | 95 wt-% of PA1 and 5 wt-% of ionomer |
| Overmolding resin composition | Blend of: | Blend of: | Blend of: |
| | 50 wt-% of long glass fibers | 50 wt-% of long glass fibers and | 50 wt-% of long glass fibers and |
| | and 50 wt-% of PA1 | 50 wt-% of PA1 | 50 wt-% of PA1 |
| Flexural strength/MPa | | | |
| Overmolded composite face | 317 | 166 | 295 |
| Composite face | — | 162 | 528 |

As shown in Table 1, the incorporation of an ionomer, i.e. a functionalized polyolefin, in the matrix resin and in the surface resin compositions of a composite structure (E1) did not cause a reduction of flexural strength or of the thermal property (expressed by the heat deflection temperature).

As shown in Table 2, the comparative overmolded composite structure (C3) comprising a matrix resin and a surface resin compositions made of a semi-aromatic polyamide suffered from low flexural strength, in the absence of a tie layer. The comparative overmolded composite structure C3 was unable to realize the high flexural strength of the comparative composite structure C1 (which comprised the same matrix resin and the surface resin compositions as C3) or the flexural strength of the overmolding resin C2:C2.

Surprisingly, the incorporation of an ionomer in the matrix resin and in the surface resin compositions of the composite structure (E1) allowed the overmolded composite structure (E2) to exhibit a comparable flexural strength in comparision with the composite structures C1 and E1 and to exhibit a strongly improved flexural strength in comparison with the comparative overmolded composite structure (C3). Indeed, a flexural strength value on the overmolded composite face of 295 MPa was obtained for the overmolded composite structure according to the present invention (E2) in comparison with a value of 166 MPa for the comparative overmolded composite structure (C3). A flexural strength value on the composite face of 528 MPa was obtained for the overmolded composite structure according to the present invention (E2) in comparison with a value of 162 MPa for the comparative overmolded composite structure (C3).

The composite structures and overmolded composite structures of the present invention (E1-E2) exhibited good mechanical properties, especially flexural strength without the need of a tie layer or the need of heating the components before the overmolding step at an excessive temperature for a long time. Such good mechanical properties contribute to the durability and safety of the article upon use and time.

What is claimed is:

1. A composite structure having a surface and suitable for overmolding an overmolding resin composition over at least a portion of the surface, which surface has at least a portion made of a surface resin composition, and comprising a fibrous material selected from the group consisting of non-woven structures, textiles, fibrous battings and combinations thereof, said fibrous material being impregnated with a matrix resin composition,
wherein the surface resin composition and the matrix resin composition are same or different and is thermoplastic compositions comprising a) one or more polyamides; and b) from at or about 1 to at or about 15 wt-% of one or more functionalized polyolefins, the weight percentages being based on the total weight of the thermoplastic composition.

2. The composite structure of claim 1, wherein the fibrous material comprises glass fibers, carbon fibers, aramid fibers, natural fibers or combinations thereof.

3. The composite structure of claim 1, wherein the one or more functionalized polyolefins are selected from the group consisting of maleic anhydride grafted polyolefins, ethylene acid copolymers, ionomers and ethylene epoxide copolymers.

4. The composite structure of claim 1, wherein the one or more functionalized polyolefins are ionomers selected from E/X/Y copolymers; wherein E is an olefin; wherein X is a α,β-unsaturated carboxylic acid selected from the group consisting of acrylic acid (AA), methacrylic acid (MAA), maleic acid, fumaric acid, itaconic acid, and half esters of maleic, maleic acid monoethylester (MAME), fumaric and itaconic acid, and Y is a softening comonomer of formula (A), wherein X is from at or about 1 wt-% to at or about 20 wt-% of the E/X/Y copolymer and wherein Y can be present in an amount of from about 0 to about 50 wt-% of the E/X/Y copolymer, wherein carboxylic acid functionalities are at least partially neutralized.

5. The composite structure of claim 4, wherein the one or more functionalized polyolefins are ionomers selected from E/X/Y copolymers where E is an olefin such as ethylene, X is a α/β-unsaturated carboxylic acid selected from the group consisting of acrylic acid (AA), methacrylic acid (MAA), maleic acid, fumaric acid, itaconic acid, and half esters of maleic, maleic acid monoethylester (MAME), fumaric and itaconic acid, and Y is a softening comonomer of formula (A), wherein X is from at or about 1 wt-% to at or about 20 wt-% of the E/X/Y copolymer and Y can be present in an amount of from about 5 to about 35 wt-% of the E/X/Y copolymer, wherein carboxylic acid functionalities are at least partially neutralized.

6. The composite structure of claim 4, wherein the carboxylic acid functionalities are at least partially neutralized by one or more metal ions selected from the group consisting of sodium, potassium, zinc, calcium and magnesium.

7. The composite structure of claim 4, wherein the one or more functionalized polyolefins are ionomers selected from E/X/Y copolymers having from at or about 3 to at or about 90% of the carboxylic acid functionalities neutralized.

8. The composite structure of claim 1, wherein the thermoplastic composition comprises one or more polyamides selected from the group consisting of fully aliphatic polyamides, semi-aromatic polyamides and blends of the same.

9. The composite structure of claim 1 in the form of a sheet structure.

10. The composite structure of claim 1 in the form of a component for automobiles, trucks, commercial airplanes, aerospace, rail, household appliances, computer hardware, hand held devices, recreation and sports, structural component for machines, structural components for buildings, structural components for photovoltaic equipments or structural components for mechanical devices.

11. A process for making a composite structure of claim 1 having a surface, said process comprises a step of:
impregnating with the matrix resin composition, the fibrous material wherein at least a portion of the surface of the composite structure is made of the surface resin composition.

12. An overmolded composite structure comprising:
i) a first component having a surface, which surface has at least a portion made of a surface resin composition, and comprising a fibrous material selected from non-woven structures, textiles, fibrous battings and combinations thereof, said fibrous material being impregnated with a matrix resin composition,
ii) a second component comprising an overmolding resin composition comprising one or more polyamides,
wherein the surface resin composition and the matrix resin composition are same or different and are chosen from the thermoplastic compositions of claim 1, and
wherein said second component is adhered to said first component over at least a portion of the surface of said first component.

13. The overmolded composite structure of claim 12 in the form of a component for automobiles, trucks, commercial airplanes, aerospace, rail, household appliances, computer hardware, hand held devices, recreation and sports, structural component for machines, structural components for buildings, structural components for photovoltaic equipments or structural components for mechanical devices.

14. A process for making an overmolded composite structure comprising a step of overmolding a second component comprising an overmolding resin composition on a first component,
wherein the first component comprises a fibrous material and has a surface,
said surface having at least a portion made of a surface resin composition,
said fibrous material being selected from the group consisting of non-woven structures, textiles, fibrous battings and combinations
thereof and said fibrous material being impregnated with a matrix resin composition,
wherein the surface resin composition and the matrix resin composition are same or different and are chosen from the thermoplastic compositions of claim 1.

15. The process of claim 14, further comprising a step of impregnating the fibrous material with the matrix resin composition, wherein at least a portion of the surface of the first component is made of the surface resin composition, said step arising before the step of overmolding.
